(19) United States
(12) Patent Application Publication
(10) Pub. No.: US 2025/0027883 A1
(43) Pub. Date: Jan. 23, 2025

(54) ELECTRONIC DEVICE AND METHOD FOR PROVIDING NOTIFICATION OF ABNORMAL STATE OF DISPLAY

(71) Applicant: SAMSUNG ELECTRONICS CO., LTD., Suwon-si (KR)

(72) Inventors: Moonsun KIM, Suwon-si (KR); Hyoungtak CHO, Suwon-si (KR); Jooyoung KANG, Suwon-si (KR); Hyunggwang KANG, Suwon-si (KR); Soohyun SEO, Suwon-si (KR); Yeonggyu YOON, Suwon-si (KR); Junghyeob LEE, Suwon-si (KR)

(21) Appl. No.: 18/902,444

(22) Filed: Sep. 30, 2024

Related U.S. Application Data
(63) Continuation of application No. PCT/KR2023/001748, filed on Feb. 7, 2023.

(30) Foreign Application Priority Data
Mar. 30, 2022 (KR) 10-2022-0039956
Jul. 8, 2022 (KR) 10-2022-0084668

(51) Int. Cl. G01N 21/88; G08B 21/18; H04M 1/02; H04M 1/24

(52) U.S. Cl. CPC G01N 21/8806; H04M 1/0268; H04M 1/24; G08B 21/18

(57) ABSTRACT

An electronic device according to an embodiment an electronic device includes a first housing, a second housing, a flexible display, a drive device, a light-emitting circuit, a light-receiving circuit, and at least one processor operably coupled with the flexible display, the drive device, the light-emitting circuit, and the light-receiving circuit. The at least one processor is configured to emit light by using the light-emitting circuit on the basis of extraction or insertion of the flexible display, identify an abnormal state in a display area of the flexible display by using the light-receiving circuit, and in response to the identification, provide a visual notification of the abnormal state in the display area of the flexible display.

### CROSS-REFERENCE TO RELATED APPLICATIONS

This application is a continuation application of International Application No. PCT/KR2023/001748 designating the United States, filed on Feb. 7, 2023, in the Korean Intellectual Property Receiving Office and claiming priority to Korean Patent Application No. 10-2022-0084668, filed on Jul. 8, 2022, and Korean Patent Application No. 10-2022-0039956, filed on Mar. 30, 2022, in the Korean Intellectual Property Office, the disclosures of which are incorporated by reference herein in their entireties.

### BACKGROUND

The following descriptions relate to an electronic device and a method for providing a notification of an abnormal state of a display.

With the development of technology, an electronic device including a flexible display is being developed. For example, at least a portion of the flexible display included in the electronic device may be inserted into or extracted from a housing of the electronic device in order to change an extent of a display area of the flexible display.

A rollable display may be inserted into or extracted from a housing of an electronic device. As the rollable display is inserted into or extracted from the housing, a foreign substance may enter into the housing of the electronic device. The foreign substance being entered may cause a problem in an operation of the electronic device.

The technical problems to be achieved in this document are not limited to those described above, and other technical problems not mentioned herein will be clearly understood by those having ordinary knowledge in the art to which the present disclosure belongs, from the following description.

### SUMMARY

According to an embodiment, an electronic device may comprise a first housing, a second housing slidably coupled to the first housing, a flexible display disposed on a surface formed by the first housing and the second housing, which is insertable into the first housing or extractable from the first housing, wherein the flexible display may include a rolling area where the flexible display is bent, a driving device for driving the second housing to slide in or slide out, a light emitting circuit disposed at an end of the first housing, which is the rolling area where the flexible display is bent, a light receiving circuit disposed at another end of the first housing, which is the rolling area where the flexible display is bent, and at least one processor operably coupled with the flexible display, the driving device, the light emitting circuit, and the light receiving circuit, wherein the at least one processor may be configured to cmit, based on insertion or extraction of the flexible display, light using the light emitting circuit, identify, an abnormal state in a display area of the flexible display using the light receiving circuit, and, in response to the identification, provide a visual notification for the abnormal state in the display area of the flexible display.

According to an embodiment, an electronic device may comprise a first housing, a second housing slidably coupled to the first housing, a flexible display disposed on a surface formed by the first housing and the second housing, which is insertable into the first housing through a first edge of the first housing or extractable from the first housing through the first edge, a driving device for inserting the flexible display into the first housing or extracting the flexible display from the first housing, a light emitting circuit disposed at an end of a second edge in contact with the first edge, which is included in the second edge of the first housing, the second edge perpendicular to the first edge, a light receiving circuit disposed together with the light emitting circuit, at the end of the second edge, and at least one processor operably coupled with the flexible display, the driving device, the light emitting circuit, and the light receiving circuit, wherein the at least one processor may be configured to emit light using the light emitting circuit, based on an input for reducing a display area of the flexible display exposed outside of the first housing, while the flexible display is inserted into the first housing through the first edge, identify an abnormal state of a partial area in the display area, based on data on the light obtained using the light receiving circuit, in response to the identification, perform ceasing the reduction the display area and perform the extension of the display area, provide a visual notification for an abnormal state of the partial area, in a state in which the display area is extended.

According to an embodiment, a method of an electronic device may comprise, based on insertion or extraction of the flexible display of the electronic device, emitting light using a light emitting circuit of the electronic device, identifying an abnormal state in the display area using a light receiving circuit of the electronic device, providing a visual notification of an abnormal state of the flexible display.

According to an embodiment, an electronic device can identify an abnormal state of a partial area in a display area using a light emitting circuit and a light receiving circuit. As the display area is reduced, the display can be inserted into a housing of the electronic device. The electronic device can extend the display area again and provide a notification to a user based on identifying the abnormal state of the partial area within the display area.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

FIG. 1 is a block diagram of an electronic device in a network environment, according to an embodiment.

FIG. 2A illustrates a front view of a first state of an electronic device according to an embodiment.

FIG. 2B illustrates a rear view of a first state of an electronic device according to an embodiment.

FIG. 2C illustrates a front view of a second state of an electronic device according to an embodiment.

FIG. 2D illustrates a rear view of a second state of an electronic device according to an embodiment.

FIG. 3A illustrates an disassembled perspective view of an electronic device according to an embodiment.

FIG. 3B illustrates a cross-sectional view illustrating an example of cutting an electronic device according to an embodiment along A-A′ of FIG. 2A.

FIG. 4 illustrates a simplified block diagram of an electronic device according to an embodiment.

FIG. 5 illustrates a flowchart about an operation of an electronic device according to an embodiment.

FIG. 6 represents an arrangement of a display, a light emitting circuit, and a light receiving circuit.

FIG. 7 illustrates a perspective view representing a light emitting circuit and a light receiving circuit included in an electronic device.

FIG. 8 illustrates an example of a path of a light emitted from a light emitting circuit toward a light receiving circuit according to an embodiment.

FIG. 9 illustrates a flowchart about an operation of an electronic device according to an embodiment.

FIG. 10 illustrates an example of an operation of an electronic device according to an embodiment.

FIG. 11 illustrates a flowchart about an operation of an electronic device according to an embodiment.

FIG. 12 illustrates an example of an operation of an electronic device according to an embodiment.

FIG. 13 illustrates an example of an operation of an electronic device according to an embodiment.

### DETAILED DESCRIPTION

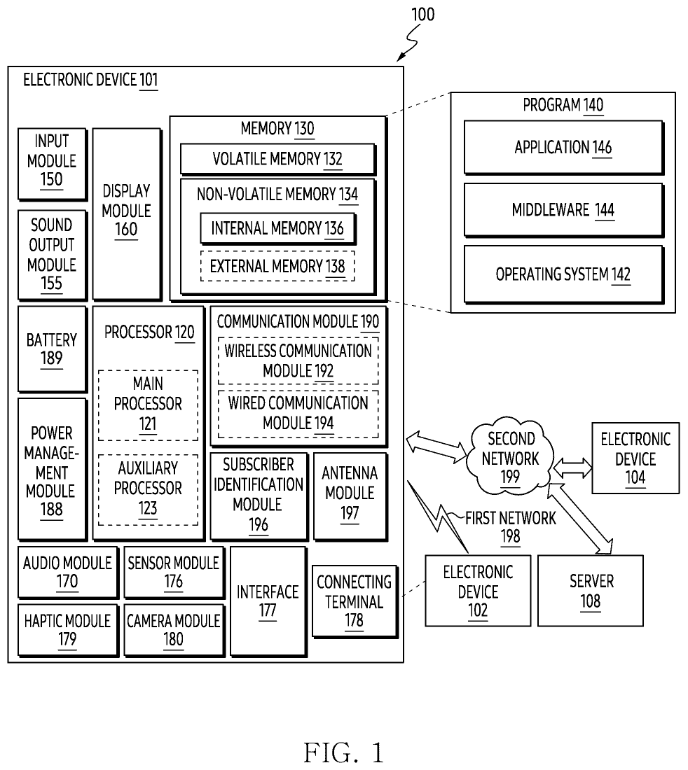

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), decp Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

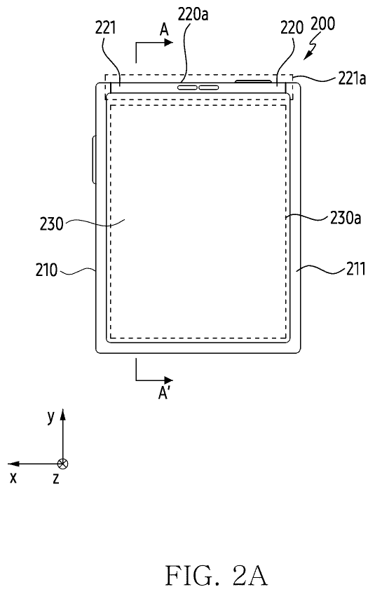

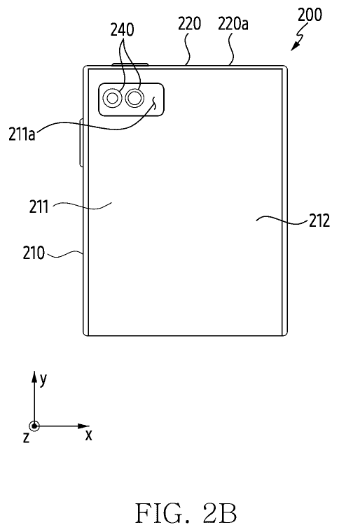

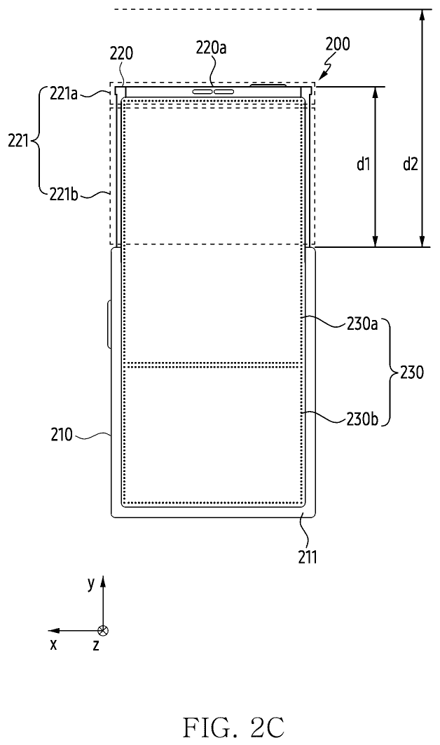

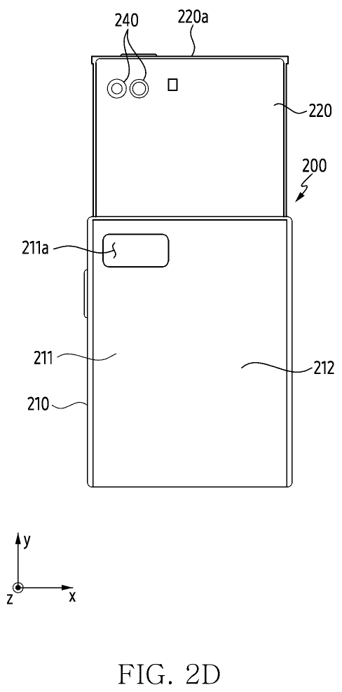

FIG. 2A illustrates a front view of a first state of an electronic device according to an embodiment.

FIG. 2B illustrates a rear view of a first state of an electronic device according to an embodiment.

FIG. 2C illustrates a front view of a second state of an electronic device according to an embodiment.

FIG. 2D illustrates a rear view of a second state of an electronic device according to an embodiment.

Referring to FIGS. 2A, 2B, 2C, and 2D, according to an embodiment, an electronic device 200 (e.g., the electronic device 101 of FIG. 1) may include a first housing 210, a second housing 220, a display 230 (e.g., the display module 160 of FIG. 1), and a camera 240 (e.g., the camera module 180 of FIG. 1). According to an embodiment, the second housing 220 may be slidable with respect to the first housing 210. For example, the second housing 220 may move with respect to the first housing 210 along a first direction (e.g., +y direction) within a specified distance. When the second housing 220 moves in the first direction, a distance between a side surface 220a of the second housing 220 facing the first direction and the first housing 210 may increase. For another example, the second housing 220 may move with respect to the first housing 210 along a second direction (e.g., −y direction) opposite to the first direction within a specified distance. When the second housing 220 moves along the second direction, a distance between the side surface 220a of the second housing 220 facing the first direction and the first housing 210 may decrease. According to an embodiment, the second housing 220 may linearly reciprocate with respect to the first housing 210, by sliding relative to the first housing 210. For example, at least a portion of the second housing 220 may be inserted into the first housing 210 or extracted from the first housing 210.

According to an embodiment, the electronic device 200 may be referred to as a “slidable electronic device”, as the second housing 220 is designed to be slidable with respect to the first housing 210. According to an embodiment, the electronic device 200 may be referred to as a “rollable electronic device”, as at least a portion of the display 230 is designed to be rolled inside the second housing 220 (or the first housing 210) based on a slide movement of the second housing 220.

According to an embodiment, a first state of the electronic device 200 may be defined as a state in which the second housing 220 moves in the second direction (e.g., a expansion state, or a slide-out state). For example, in the first state of the electronic device 200, the second housing 220 may be movable in the first direction, but may not be movable in the second direction. In the first state of the electronic device 200, the distance between the side surface 220a of the second housing 220 and the first housing 210 may increase according to a movement of the second housing 220, but may not decrease. For another example, in the first state of the electronic device 200, a portion of the second housing 220 may be extracted from inside of the first housing 210, but may not be insertable. According to an embodiment, the first state of the electronic device 200 may be defined as a state in which a second area 230b of the display 230 is not visually exposed from outside of the electronic device 200. For example, in the first state of the electronic device 200, the second area 230b of the display 230 may be located inside an internal space (not shown) of the electronic device 200 formed by the first housing 210 and/or the second housing 220, and may not be visible from outside of the electronic device 200.

According to an embodiment, a second state of the electronic device 200 may be defined as a state in which the second housing 220 moves in the first direction (e.g., a contraction state, or a slide-in state). For example, in the second state of the electronic device 200, the second housing 220 may be movable in the second direction, but may not be movable in the first direction. In the second state of the electronic device 200, the distance between the side surface 220a of the second housing 220 and the first housing 210 may decrease as the second housing 220 moves, but may not increase. For another example, in the second state of the electronic device 200, a portion of the second housing 220 may be inserted into the first housing 210, but may not be extracted from the first housing 210. According to an embodiment, the second state of the electronic device 200 may be defined as a state in which the second area 230b of the display 230 is visually exposed from outside of the electronic device 200. For example, in the second state of the electronic device 200, the second area 230b of the display 230 may be extracted from an internal space of the electronic device 200 and visible from outside of the electronic device 200.

According to an embodiment, in case that the second housing 220 moves from the first housing 210 in the first direction, at least a portion of the second housing 220 and/or the second area 230b of the display 230 may be extracted from the first housing 210 by an extraction length d1 corresponding to a moving distance of the second housing 220. According to an embodiment, the second housing 220 may reciprocate within a specified distance d2. According to an embodiment, the extraction length d1 may have a size of approximately 0 to a specified distance d2.

According to an embodiment, the state of the electronic device 200 may be convertible between the second state and/or the first state, by a manual operation by a user or an automatic operation by a driving module (not shown) disposed inside the first housing 210 or the second housing 220. According to an embodiment, the driving module may be triggered based on a user input. According to an embodiment, a user input for triggering an operation of the driving module may include a touch input, a force touch input, and/or a gesture input through the display 230. According to another embodiment, a user input for triggering an operation of a driving module may include a speech input (voice input) or an input of a physical button exposed to outside of a first housing 210 or a second housing 220. According to an embodiment, the driving module may be driven in a semi-automatic manner in which an operation is triggered when a manual operation by a user's external force is detected.

According to an embodiment, the first state of the electronic device 200 may be referred to as a first shape, and the second state of the electronic device 200 may be referred to as a second shape. For example, the first shape may include a normal state, a contraction state, or a closed state, and the second shape may include an open state. According to an embodiment, the electronic device 200 may form a third state (e.g., an intermediate state) which is a state between the first state and the second state. For example, the third state may be referred to as a third shape, and the third shape may include a free stop state.

According to an embodiment, the display 230 may be visible (or viewable) from outside through a front direction (e.g., −z direction) of the electronic device 200, in order to display a visual information to a user. For example, the display 230 may include a flexible display. According to an embodiment, the display 230 may be disposed at the second housing 220 and, according to a movement of the second housing 220, may be extracted from an internal space (not shown) of the electronic device 200 or inserted into the internal space of the electronic device 200. The internal space of the electronic device 200 may mean a space within the first housing 210 and the second housing 220 formed by a coupling of the first housing 210 and the second housing 220. For example, in the first state of the electronic device 200, at least a portion of the display 230 may be rolled into the internal space of the electronic device 200 and inserted. In a state that at least the portion of the display 230 is inserted into the internal space of the electronic device 200, when the second housing 220 moves in the first direction, at least the portion of the display 230 may be extracted from the internal space of the electronic device 200. For another example, when the second housing 220 moves in the second direction, at least a portion of the display 230 may be rolled into the electronic device 200 and inserted into the internal space of the electronic device 200. As at least a portion of the display 230 is extracted or inserted, an area of the display 230 visible from outside of the electronic device 200 may be extended (or expanded) or reduced. According to an embodiment, the display 230 may include a first area 230a and a second area 230b.

According to an embodiment, the first area 230a of the display 230 may mean an area of the display 230 that may be visible from outside of the electronic device 200 regardless of whether the electronic device 200 is in the second state or the first state. For example, the first area 230a may mean a partial area of the display 230 that is not rolled into the internal space of the electronic device 200. According to an embodiment, when the second housing 220 moves, the first area 230a may move together with the second housing 220. For example, when the second housing 220 moves along the first direction or the second direction, the first area 230a may move along the first direction or the second direction together with the second housing 220 on the front surface of the electronic device 200.

According to an embodiment, the second area 230b of the display 230 may be connected to the first area 230a and inserted into the internal space of the electronic device 200 or extracted from the internal space of the electronic device 200 to the outside according to the movement of the second housing 220. For example, in the first state of the electronic device 200, the second area 230b of the display 230 may be a state of being inserted into the internal space of the electronic device 200 while being rolled. The second area 230b of the display 230 may be inserted into the internal space of the electronic device 200 and may not be visible from outside, in the first state of the electronic device 200. For another example, the second area 230b of the display 230, in the second state of the electronic device 200, may be in a state that is extracted from the internal space of the electronic device 200. The second area 230b of the display 230 may be visible from outside of the electronic device 200 in the second state.

According to an embodiment, in the first state of the electronic device 200, an extent of the display 230 visible from outside of the electronic device 200 may include only the first area 230a of the display 230. In the second state of the electronic device 200, an extent of the display 230 visible from outside of the electronic device 200 may include at least a portion of the first area 230a and the second area 230b of the display 230.

According to an embodiment, the first housing 210 of the electronic device 200 may include a back cover 211 surrounding an internal space of the first housing 210 and a rear plate 212 surrounding a rear surface of the back cover 211. The second housing 220 of the electronic device 200 may include a front cover 221 surrounding the internal space of the electronic device 200.

According to an embodiment, the front cover 221 may include a first cover area 221a of the front cover 221 that is not inserted into the first housing 210 and a second cover area 221b that is inserted into or extracted from the first housing 210. The first cover area 221a of the front cover 221 may always be visible regardless of whether the electronic device 200 is in the second state and the first state. According to an embodiment, at least a portion of the first cover area 221a of the front cover 221 may form a side surface 220a of the second housing 220. According to an embodiment, the second cover area 221b of the second housing 220 may not be visible in the first state, but may be visible in the second state.

A camera 240 may obtain an image with respect to a subject based on receiving light from outside of the electronic device 200. According to an embodiment, the camera 240 may include one or more lenses, an image sensor, and/or an image signal processor. According to an embodiment, the camera 240 may be disposed at the second housing 220 to face a rear surface of the electronic device 200 opposite to the front surface of the electronic device 200 in which the first area 230a of the display 230 is disposed. For example, the camera 240 is disposed at the front cover 221 of the second housing 220, and when the electronic device 200 is in the first state, it may be visible from outside of the electronic device 200 through an opening 211a formed at the back cover 211. For another example, the camera 240 is disposed at the front cover 221 of the second housing 220 and is covered by the back cover 211 and/or the rear plate 212 when the electronic device 200 is in the first state, so that it may not be visible from outside of the electronic device 200.

According to an embodiment, the camera 240 may include a plurality of cameras. For example, the camera 240 may include a wide-angle camera, an ultra-wide-angle camera, a telephoto camera, a proximity camera, and/or a depth camera. However, the camera 240 is not necessarily limited to include a plurality of cameras, and may include one camera.

According to an embodiment, the camera 240 may further include a camera (not shown) directed toward the front surface of the electronic device 200 in which the first area 230a of the display 230 is disposed. When the camera 240 is directed toward the front of the electronic device 200, the camera 240 may be an under display camera (UDC) disposed below the display 230 (e.g., +z direction from the display 230), but is not limited thereto.

According to an embodiment, the electronic device 200 may include a sensor module (not shown) and/or a camera module (not shown) disposed under the display 230. The sensor module may detect an external environment based on information (e.g., light) received through the display 230. According to an embodiment, the sensor module may include at least one of a receiver, a proximity sensor, an ultrasonic sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, a motor encoder, or an indicator. According to an embodiment, at least a portion of sensor modules of the electronic device 200 may be visually exposed from outside through a partial area of the display 230. According to an embodiment, the electronic device 200 may detect an extraction length (e.g., a length A) using the sensor module. According to an embodiment, the electronic device 200 may generate extraction information on degree of extraction detected by a sensor. For example, the electronic device 200 may detect and/or identify degree of extraction of the second housing 220 using the extraction information. According to an embodiment, the extraction information may include information on an extraction length of the second housing 220.

According to an embodiment, a coupling form of the first housing 210 and the second housing 220 is not limited to a shape and a coupling illustrated in FIGS. 2A, 2B, 2C, and 2D, and may be implemented by a combination and/or coupling of other shape or component.

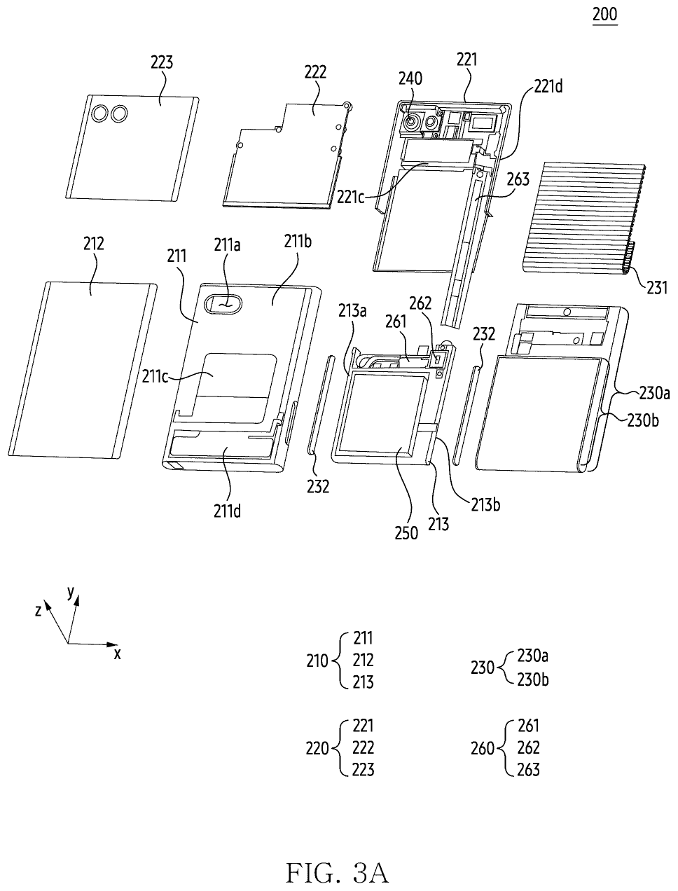

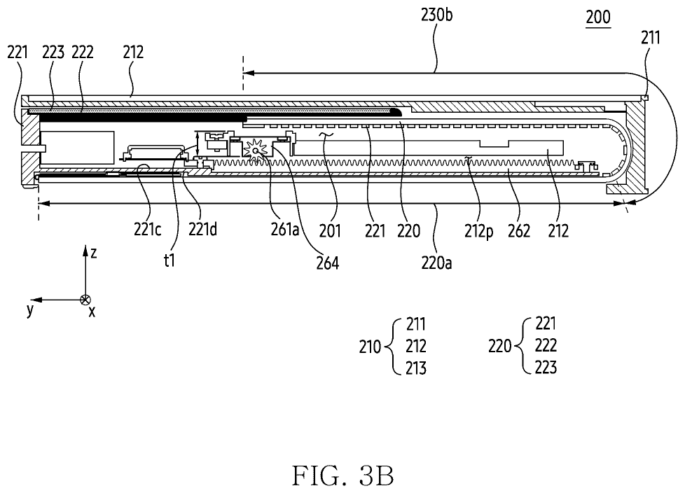

FIG. 3A illustrates an disassembled perspective view of an electronic device according to an embodiment.

FIG. 3B illustrates a cross-sectional view illustrating an example of cutting an electronic device according to an embodiment along A-A′ of FIG. 2A.

Referring to FIGS. 3A and 3B, an electronic device 200 according to an embodiment may include a first housing 210, a second housing 220, a display 230, a camera 240, a battery 250 (e.g., the battery 189 of FIG. 1) and a driving unit 260. According to an embodiment, the first housing 210 and the second housing 220 may be coupled to each other to form an internal space 201 of the electronic device 200. For example, in a first state of the electronic device 200, a second area 230b of the display 230 may be accommodated in the internal space 201.

According to an embodiment, the first housing 210 may include a back cover 211, a rear plate 212, and a frame cover 213. According to an embodiment, the back cover 211, the rear plate 212, and the frame cover 213 included in the first housing 210 are coupled to each other, so that when the second housing 220 moves with respect to the first housing 210, it may not move together with the second housing 220.

According to an embodiment, the back cover 211 may form at least a portion of an external surface of the electronic device 200. For example, the back cover 211 may form at least a portion of a side surface of the electronic device 200 and at least a portion of a rear surface of the electronic device 200. According to an embodiment, the back cover 211 may provide a surface on which the rear plate 212 is mounted. The rear plate 212 may be mounted on a surface 211b of the back cover 211.

According to an embodiment, the frame cover 213 may support internal components of the electronic device 200. For example, the frame cover 213 may accommodate at least a portion of a battery 250 and a driving unit 260. The battery 250 and the driving unit 260 may be accommodated in at least one of a recess or a hole included in the frame cover 213. According to an embodiment, the frame cover 213 may be surrounded by the back cover 211. For example, in the first state of the electronic device 200, a surface 213a of the frame cover 213 on which the battery 250 is disposed may face the back cover 211 and/or the second area 230b of the display 230. For another example, in the first state of the electronic device 200, another surface 213b of the frame cover 213 facing the surface 213a of the frame cover 213 may face the first area 230a of the display 230 or the front cover 221. For example, the frame cover 213 may include aluminum as a material, but is not limited thereto.

According to an embodiment, the second housing 220 may include a front cover 221, a rear cover 222, and a slide cover 223. According to an embodiment, the front cover 221, the rear cover 222, and the slide cover 223 are coupled to each other, so that when the second housing 220 moves relative to the first housing 210, it may move together with the second housing 220. The front cover 221 may support internal components of the electronic device 200. For example, the camera 240 may be disposed on a surface 221c of the front cover 221 which faces the internal space 201. Another surface 221d of the front cover 221 which faces the surface 221c of the front cover 221 may face the first area 230a of the display 230 when the electronic device 200 is in the first state. According to an embodiment, the rear cover 222 may be coupled to the front cover 221, to protect components of the electronic device 200 disposed on the front cover 221. For example, the rear cover 222 may cover a portion of the surface 221c of the front cover 221. According to an embodiment, the slide cover 223 may be disposed on the rear cover 222, and may form an external surface of the electronic device 200 together with the rear plate 212 and the back cover 211. The slide cover 223 may be coupled to a surface of the rear cover 222, and may protect the rear cover 222 and/or the front cover 221.

According to an embodiment, when the electronic device 200 is in the first state, as at least a portion of the display 230 is rolled into an internal space 201, the display 230 may be bent. According to an embodiment, the display 230 may cover at least a portion of the frame cover 213 and at least a portion of the front cover 221. For example, when the electronic device 200 is in the first state, the display 230 may cover the other surface 221d of the front cover 221, and pass between the front cover 221 and the back cover 211, may be extended facing the internal space 201. The display 230 may surround the frame cover 213 after passing between the front cover 221 and the back cover 211. The display 230 may cover the surface 213a of the frame cover 213 within the internal space 201. According to an embodiment, when the second housing 220 moves in the first direction, the second area 230b of the display 230 may be extracted from the internal space 201. For example, as the second housing 220 moves in the second direction, the display 230 may pass between the front cover 221 and the back cover 211, and may be extracted from the internal space 201.

According to an embodiment, the first area 230a of the display 230 may be in contact with the other surface 221d of the front cover 221. For example, the first area 230a may be in contact with the other surface 221d of the front cover 221, and extend parallel to the other surface 221d of the front cover 221. The first area 230a may have a planar shape substantially, by extending parallel to the other surface 221d of the front cover 221. According to an embodiment, the first area 230a of the display 230 may not be deformed according to a movement of the second housing 220. For example, the first aera 230a may move as the second housing 220 moves while maintaining the planar shape.

According to an embodiment, the second area 230b of the display 230 may be deformable according to a movement of the second housing 220. For example, when the electronic device 200 is in the first state, the second area 230b may be bent with a curvature within the internal space 201 of the electronic device 200. When the second housing 220 moves in the first direction (e.g., +y direction), at least a portion of the second area 230b may be extracted from the internal space 201 of the electronic device 200 and may be in contact with the other surface 221d of the front cover 221. When at least a portion of the second aera 230b is in contact with the other surface 221d of the front cover 221, at least a portion of the second area 230d does not have a curvature on the another surface 221d of the front cover 221 and may have a planar shape. For another example, when the second housing 220 moves in the second direction (e.g., −y direction), at least a portion of the second area 230b may be inserted into the internal space 201 of the electronic device 200. At least a portion of the second area 230b may be bent to have a curvature while being inserted into the internal space 201 of the electronic device 200.

According to an embodiment, the electronic device 200 may include a support member 231 supporting the display 230 and a guide rail 232. The support member 231 may include a plurality of bars coupled to each other and may be manufactured in a shape corresponding to a shape of the second area 230b of the display 230. For example, the support member 231 may include a plurality of bars extended in a third direction (e.g., +x direction) perpendicular to the first direction (e.g., +y direction). The support member 231 may be disposed at the second area 230b of the display 230. According to an embodiment, as the display 230 moves, the support member 231 may move together with the display 230. According to an embodiment, in the first state in which the second area 230b of the display 230 is rolled into the internal space 201, the support member 231 may be rolled into the internal space 201 together with the second area 230b of the display 230.

According to an embodiment, the guide rail 232 may guide a movement of the support member 231. For example, as the display 230 moves, the support member 231 may move along the guide rail 232 coupled to the frame cover 213. According to an embodiment, the guide rail 232 may include a plurality of guide rails 232 spaced apart from each other at both edges of the frame cover 213 spaced apart from each other along a third direction (e.g., +x direction) perpendicular to the first direction.

According to an embodiment, the driving unit 260 may provide a driving force to the second housing 220 so that the second housing 220 may move relatively with respect to the first housing 210. According to an embodiment, the driving unit 260 may include a motor 261, a pinion gear 262, a rack gear 263, and a bracket 264. The motor 261 may receive power from the battery 250 and provide the driving force to the second housing 220. According to an embodiment, the motor 261 may be disposed in the first housing 210 so that when the second housing 220 moves with respect to the first housing 210, it may not move together with the second housing 220. For example, the motor 261 may be disposed in a recess formed in the frame cover 213. According to an embodiment, the pinion gear 262 may be coupled to the motor 261 and rotate by the driving force provided from the motor 261. For example, the pinion gear 262 is rotatably coupled to a shaft 261a, which is a drive shaft of the motor 261, and may be rotatable with respect to the motor 261. According to an embodiment, the rack gear 263 may engage with the pinion gear 262 and move according to a rotation of the pinion gear 262. For example, the rack gear 263 may linearly reciprocate in the first direction or the second direction according to the rotation of the pinion gear 262. According to an embodiment, the rack gear 263 may be disposed in the second housing 220. For example, the rack gear 263 may be coupled to the front cover 221 included in the second housing 220. According to an embodiment, the rack gear 263 may be movable inside an operating space 213p formed in the frame cover 213. According to an embodiment, the bracket 264 may press the pinion gear 262 so that the driving force of the motor 261 is smoothly transmitted to the rack gear 263. For example, the bracket 264 may surround at least a portion of the pinion gear 262 and press the pinion gear 262 in a direction (e.g., +z direction) which faces from the surface 221c of the front cover 221 to the other surface 221d of the front cover 221.

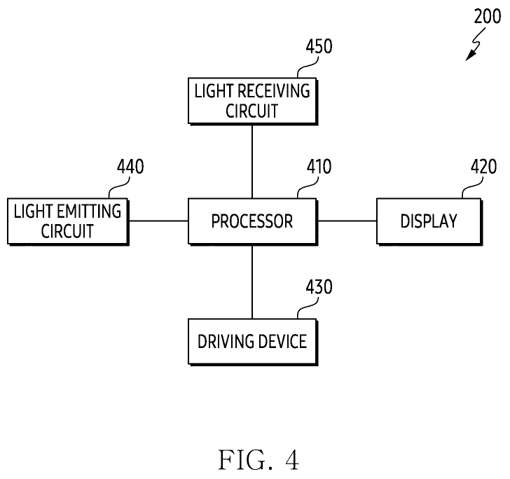

According to an embodiment, when the pinion gear 262 rotates in the first rotation direction (e.g., clockwise in FIG. 4B), the rack gear 263 may move in the first direction (e.g., +y direction). When the rack gear 263 moves along the first direction, the second housing 220 coupled to the rack gear 263 may move along the first direction. As the second housing 220 moves along the first direction, an extent of the display 230 visible from outside of the electronic device 200 may be extended. When the pinion gear 262 rotates in the second rotation direction (e.g., counterclockwise in FIG. 4B), the rack gear 263 may move in the second direction (e.g., −y direction). When the rack gear 263 moves along the second direction, the second housing 220 coupled to the rack gear 263 may move along the second direction. As the second housing 220 moves along the second direction, an extent of the display 230 visible from outside of the electronic device 200 may be reduced.

In the above description, the motor 261 and the pinion gear 262 are disposed in the first housing 210, and the rack gear 263 is disposed in the second housing 220, but embodiments may not be limited thereto. According to embodiments, the motor 261 and the pinion gear 262 may be disposed in the second housing 220, and the rack gear 263 may be disposed in the first housing 210.

According to an embodiment, an abnormal state of the display in the electronic device (e.g., the electronic device 101 of FIG. 1 or the electronic device 200 of FIGS. 2A to 3B) may be identified. For example, the electronic device may further include a light emitting circuit for emitting light and a light receiving circuit for receiving the emitted light. The electronic device may emit the light using the light emitting circuit and receive the emitted light using the light receiving circuit. The electronic device may identify an abnormal state of the display by receiving the light emitted from the light emitting circuit using the light receiving circuit. In the following description, various embodiments for identifying an abnormal state of a display using a light emitting circuit and a light receiving circuit and providing a notification about an abnormal state of a display may be described.

FIG. 4 illustrates a simplified block diagram of an electronic device according to an embodiment.

Referring to FIG. 4, according to an embodiment, an electronic device 200 may include some or all of the components of the electronic device 101 illustrated in FIG. 1. The electronic device 200 may include some or all of the components of the electronic device 200 illustrated in FIGS. 2A to 3B. For example, the electronic device 200 may correspond to the electronic device 101 illustrated in FIG. 1. The electronic device 200 may correspond to the electronic device 200 illustrated in FIGS. 2A to 3B.

According to an embodiment, the electronic device 200 may include a processor 410, a display 420, a driving device 430, a light emitting circuit 440, and/or a light receiving circuit 450. According to an embodiment, the electronic device 200 may include at least one of the processor 410, the display 420, the driving device 430, the light emitting circuit 440, and the light receiving circuit 450. For example, at least a portion of the processor 410, the display 420, the driving device 430, the light emitting circuit 440, and the light receiving circuit 450 may be omitted according to an embodiment.

According to an embodiment, the processor 410 may be operatively (or operably) coupled with or connected with the display 420, the driving device 430, the light emitting circuit 440, and the light receiving circuit 450. For example, the processor 410 may control the display 420, the driving device 430, the light emitting circuit 440, and the light receiving circuit 450. The display 420, the driving device 430, the light emitting circuit 440, and the light receiving circuit 450 may be controlled by the processor 410. For example, the processor 410 may be configured with at least one processor. The processor 410 may include at least one processor. For example, the processor 410 may correspond to the processor 120 of FIG. 1.

According to an embodiment, the processor 410 may include a hardware component for processing data based on one or more instructions. For example, hardware components for processing data may include an arithmetic and logic unit (ALU), a field programmable gate array (FPGA), and/or a central processing unit (CPU).

According to an embodiment, the electronic device 200 may include the display 420. For example, the display 420 may be a rollable display or a flexible display. For example, the display 420 may be configured such that at least a portion of the display 420 may be inserted into a housing (e.g., a second housing 220) of the electronic device 200 or extracted from the housing of the electronic device 200. For example, the display 420 may be inserted into the first housing through a first edge of the first housing. The display 420 may be extracted from the first housing through the first edge of the first housing. For example, the display 420 may correspond to the display module 160 of FIG. 1. For example, the display 420 may correspond to the display 230 of FIGS. 2A to 3B.

According to an embodiment, the display 420 may be deformable. The display 420 may provide a different size of a display area according to a state of the electronic device 200.

For example, when a state of the electronic device 200 is a first state, the display 420 may provide a display area having the first size. When a state of the electronic device 200 is a second state, the display 420 may provide a display area having the second size.

For example, based on that the state of the electronic device is the first state, a display area in which the display 420 is exposed to a minimum size may be provided. Based on that the state of the electronic device 200 is the second state, a display area in which the display 420 is exposed to a maximum size may be provided.

For example, in the first state, the display area of the display 420 may be set to be the smallest. For example, the first state may be a state providing a visible area having a minimum size. For example, the first state may be a state in which the display 420 provides a display area exposed to a minimum size. The first state may be referred to as a contraction state of the display 420.

For another example, in the second state, the display area of the display 420 may be set to be the largest. For example, the second state may be a state providing a visible area having a maximum size. For example, the second state may be a state in which the display 420 provides a display area exposed to a maximum size. The second state may be referred to as an extension state of the display 420.

For another example, the electronic device 200 may be set to a third state that is an intermediate state between the first state and the second state. Based on that the state of the electronic device 200 is the third state, the display 420 may provide a display area having a third size. The third size may be set to be larger than the first size and smaller than the second size.

According to an embodiment, the first to third states described above are for convenience of explanation, and the first to third states described above may be changed according to an embodiment.

According to an embodiment, the electronic device 200 may include the driving device 430. For example, the driving device 430 (e.g., the driving unit 260 of FIG. 3A) may operate so that the second housing of the electronic device 200 (e.g., the second housing 220 of FIG. 3A) moves or slides with respect to the first housing (e.g., the first housing 210 of FIG. 3A). For example, the driving device 430 may control (or drive) the second housing (e.g., the second housing 220 of FIG. 3A) to slide in or slide out. The processor 410 may drive the second housing 220 to slide in or slide out using the driving device 430.

For example, the driving device 430 may include a motor (e.g., the motor 261 of FIG. 3A), a rack gear (e.g., the rack gear 263 of FIG. 3A), and a pinion gear (e.g., the pinion gear 262 of FIG. 3A). For example, a shaft of the motor (e.g., the shaft 261A of FIG. 3A) may be coupled to the pinion gear. The processor 410 may move the rack gear coupled to the first housing based on rotating the pinion gear using the motor.

According to an embodiment, the electronic device 200 may include the light emitting circuit 440 and the light receiving circuit 450. For example, the light emitting circuit 440 may be used to emit light to the light receiving circuit 450. For example, the light emitting circuit 440 may emit the light to the light receiving circuit 450 based on a directional beam. For example, the light receiving circuit 450 may be used to receive the light emitted from the light emitting circuit 440. For example, the light receiving circuit 450 may receive the light emitted from the light emitting circuit 440 based on the directional beam.

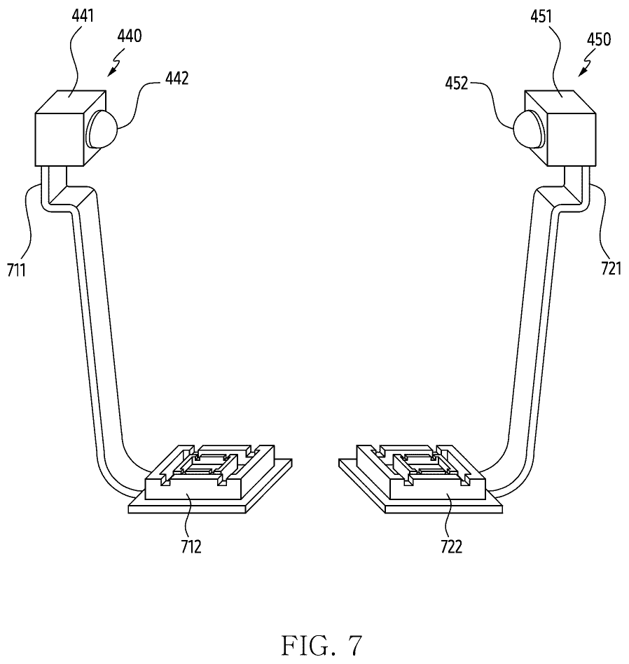

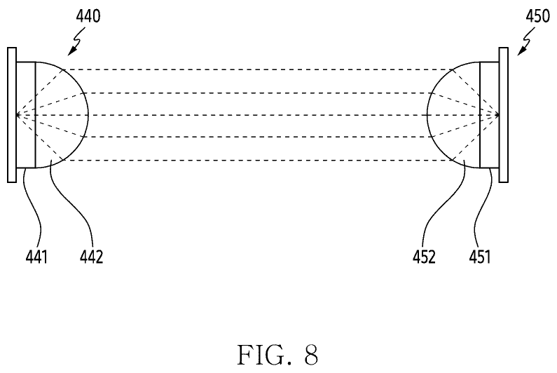

For example, the light emitting circuit 440 may be disposed at an end of the second edge in contact with the first edge of the first housing. The second edge may be perpendicular to the first edge of the first housing that the display 420 is inserted or extracted. The light receiving circuit 450 may be disposed at an end of the third edge which is in contact with the first edge. The third edge may face the second edge. A specific example of the light emitting circuit 440 and the light receiving circuit 450 will be described later with reference to FIGS. 7 to 8.

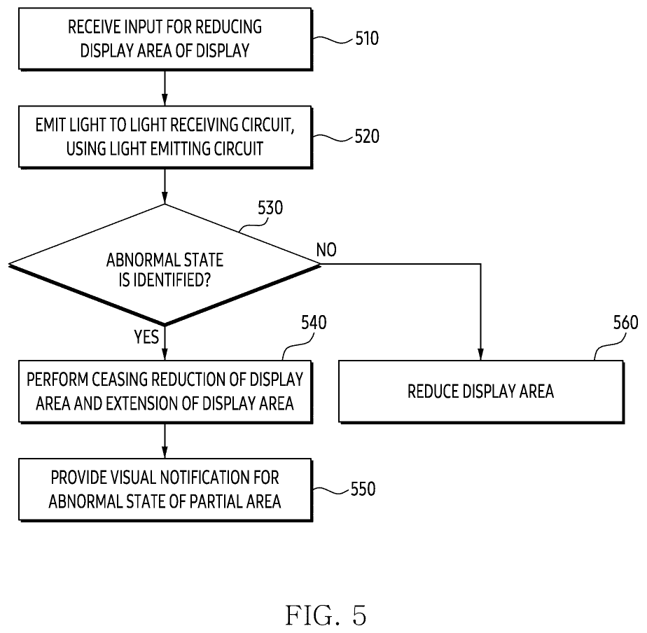

FIG. 5 illustrates a flowchart about an operation of an electronic device according to an embodiment.

Referring to FIG. 5, in operation 510, a processor 410 may receive an input for reducing a display area of a display 420 (e.g., a flexible display). For example, the processor 410 may receive an input for reducing the display area of the display 420 exposed outside a first housing. For example, the processor 410 may receive an input for reducing the display area based on an input with respect to a physical button. For another example, the processor 410 may receive an input for reducing the display area based on a voice input.

For example, the processor 410 may receive an input for reducing a size of the display area in a state in which the size of the display area is extended to the maximum (e.g., a second state). The processor 410 may receive an input for changing a state of the electronic device 200 from a state in which the size of the display area is extended to the maximum size (e.g., the second state) to a state in which the size of the display area is reduced to the minimum size (e.g., a first state).

In operation 520, the processor 410 may emit light to a light receiving circuit 450 using a light emitting circuit 440. For example, the processor 410 may emit the light using the light emitting circuit 440 based on the extraction or insertion of a display 420. For example, the processor 410 may emit the light to the light receiving circuit 450 using a light emitting circuit 440 while the display area is reduced based on an input for reducing the display area of the display 420 (e.g., flexible display) exposed outside the first housing.

According to an embodiment, the processor 410 may reduce the display area based on an input for reducing the display area. For example, the processor 410 may reduce the display area by using the driving device 430 from a state in which the display area is extended to the maximum. The processor 410 may emit light to the light receiving circuit 450 using the light emitting circuit 440 while the display area is reduced.

According to an embodiment, the processor 410 may emit the light by using the light emitting circuit 440. For example, the light emitting circuit 440 may include a light source element and a first lens. The light source element may be used to emit light. The processor 410 may emit light using a light source element. The processor 410 may adjust an intensity of the light of the light source element. The first lens may change a path of the light to emit the light emitted from the light source element to the light receiving circuit 450 based on a directional beam.

For example, the processor 410 may emit the light based on the directional beam from the light emitting circuit 440 to the light receiving circuit 450 in a direction parallel to a first edge at which the display 420 is inserted into the first housing of the electronic device 200. For example, a portion of the display area (e.g., a partial area within the display area) of the display 420 may be changed from a planar portion to a curved portion by moving according to the reduction of the display area. The light emitted from the light emitting circuit 440 may be emitted to the light receiving circuit 450 along the curved portion.

In operation 530, the processor 410 may identify whether an abnormal state is identified (or found). For example, the processor 410 may identify whether an abnormal state in the display area of the display 420 is identified using the light receiving circuit 450. For example, the processor 410 may identify whether an abnormal state is identified in a partial area within the display area based on data on the light obtained using the light receiving circuit 450.

According to an embodiment, the processor 410 may receive (or identify) the light emitted from the light emitting circuit 440 by using the light receiving circuit 450. For example, the light receiving circuit 450 may include a light receiving element and a second lens. The second lens may change the path of the light so that the emitted light based on the directional beam is concentrated in a focus. The light receiving element may be used to receive the concentrated light. The processor 410 may receive the concentrated light using the light receiving element. The processor 410 may obtain the data on the light by using light receiving circuit 450.

According to an embodiment, the processor 410 may identify the abnormal state in the display area of the display 420 by using the light receiving circuit 450. For example, the processor 410 may identify the abnormal state of the partial area in the display area based on the data on the light. For example, the processor 410 may identify an amount of light received using the light receiving circuit 450 based on the data on the light. The processor 410 may identify the abnormal state of the partial area based on identifying that the identified amount of light is lower than a reference amount of light.

For example, when the display area of the display 420 is in a normal state, there may be no obstacle to the light emitted along the curved portion of the display area. The processor 410 may identify that the amount of light identified by using the light receiving circuit 450 is constantly maintained. The processor 410 may identify that the display area of the display 420 is in a normal state based on identifying that the amount of light identified constantly maintained.

For another example, when a foreign substance exists on the display area of the display 420 or the display area of the display 420 is expanded, a portion of the light emitted from the light emitting circuit 440 may not be received by the light receiving circuit 450. For example, the processor 410 may identify that the amount of the light of the identified light is reduced by using the light receiving circuit 450. The processor 410 may identify an abnormal state of the display 420 based on identifying that the amount of the identified light is reduced. For another example, the processor 410 may identify that the amount of light identified using the light receiving circuit 450 is lower than the reference amount of light. The processor 410 may identify an abnormal state of the partial area of the display 420 based on identifying that the amount of the identified light is lower than the reference amount of light.

For example, the processor 410 may identify the amount of light received using the light receiving circuit 450 based on the data on the light. In a time point that the processor 410 identifies that the amount of light is lower than the reference amount of light, a first area corresponding to a curved portion of the display area, a second area extended from the curved portion of the display area by a reference distance in a first direction, and the third area extended from the curved portion of the display area by the reference distance in a second direction may be identified as a partial area. For example, the first direction may be perpendicular to the first edge and may mean a direction in which the display area is reduced. The second direction is perpendicular to the first edge and may mean a direction in which the display area is extended. The first direction may be opposite to the second direction.

In operation 540, when the abnormal state of the partial area of the display 420 is identified, the processor 410 may perform ceasing (i.e., stop) the reduction of the display area and perform the extension of the display area. For example, the processor 410 may perform ceasing the reduction of the display area and perform the extension of the display area in response to identifying the abnormal state of the partial area.

According to an embodiment, the processor 410 may cease the reduction of the display area in response to identifying the abnormal state of the partial area. The processor 410 may cease the reduction of the display area and perform the extension of the display area again. For example, the partial area of the display area may be changed from a planar portion to a curved portion by moving according to the reduction of the display area. The partial area of the display area may be changed from the curved portion to the flat portion by moving according to the extension of the display area.

According to an embodiment, when the partial area in which the abnormal state is identified is inserted into the first housing of the electronic device 200, damage of the display 420 may occur. In order to prevent the damage of the display 420, the processor 410 may cease the reduction of the display area and perform the extension of the display area, in response to the identification of the abnormal state in the partial area.

In operation 550, the processor 410 may provide a visual notification for the abnormal state of the display area. For example, the processor 410 may provide the visual notification for the abnormal state of the partial area, in a state in which the display area is extended.

For example, when a foreign substance exists on the partial area in the display area of the display 420, the processor 410 may provide a visual notification representing that the foreign substance exists in the partial area. For another example, when the partial area in the display area of the display 420 is expanded, the processor 410 may provide a visual notification representing that the partial area is expanded.

According to an embodiment, the processor 410 may identify a location where an abnormal state occurs in the partial area. The processor 410 may provide the visual notification by displaying a visual affordance at the location where the abnormal state occurs. For example, the visual affordance may be displayed to guide a transition from the abnormal state to a normal state. According to an embodiment, the processor 410 may display an element indicating the location where the abnormal state occurs in the partial area together with the visual notification. For example, the processor 410 may display the element indicating the location where the abnormal state occurs by changing luminance of the partial area. For another example, the processor 410 may display the element indicating the location where the abnormal state occurs by displaying a visual object in the partial area.

In operation 560, when the abnormal state is not identified in the display area of the display 420, the processor 410 may reduce the display area. For example, the processor 410 may reduce the display area based on that the abnormal state is not identified in the display area of the display 420. For example, the processor 410 may identify the normal state of the display area. The processor 410 may reduce the display area to the minimum size based on a normal state of the display area.

According to an embodiment, the processor 410 may identify that the amount of light received using the light receiving circuit 450 is constantly maintained while the display area is reduced. The processor 410 may maintain the reduction of the display area based on identifying that the amount of light is constantly maintained. The processor 410 may reduce the display area until the display area is reduced to the minimum size.

According to an embodiment, the processor 410 may identify that the amount of light received using the light receiving circuit 450 is equal to or greater than the reference amount of light while the display area is reduced. The processor 410 may maintain the reduction of the display area based on identifying that the amount of light is equal to or greater than the reference amount of light. The processor 410 may reduce the display area until the display area is reduced to the minimum size.

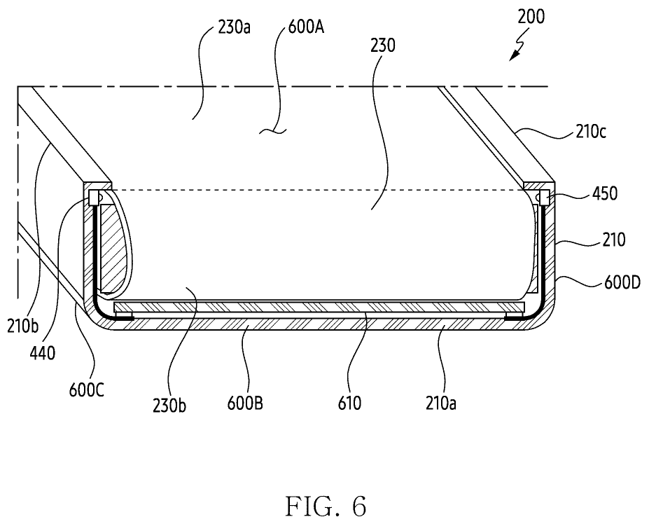

FIG. 6 represents an arrangement of a display, a light emitting circuit, and a light receiving circuit.

Referring to FIG. 6, an electronic device 200 may include a first housing 210, a display 230, a light emitting circuit 440, and/or a light receiving circuit 450.

According to an embodiment, a second housing 220 (e.g., the second housing 220 of FIG. 2A) may be coupled to the first housing 210 to be insertable or extractable. The first housing 210 may include a first edge 210a in a direction opposite to an extraction direction of the second housing 220, a second edge 210b extended from an end of the first edge 210a in the extraction direction, and a third edge 210c extended from another end of the first edge 210a in the extraction direction. The display 230 may be inserted into or extracted from the first edge 210a of the first housing 210.

According to an embodiment, the display 230 may include a first area 230a visible from outside of the electronic device 200 regardless of a state of the electronic device 200, and, when the electronic device 200 is in a first state, a second area 230b rolled into an internal space of the electronic device 200 formed by the first housing 210 and the second housing 220. For example, the first area 230a of the display 230 is always exposed to outside through a first surface 600A of the electronic device 200 and may move together with the second housing 220 as the second housing 220 moves. The second area 230b of the display 230 may pass through an area of the first edge 210a and may be rolled into the internal space of the electronic device 200. For example, the second area 230b of the display 230 passing through the area of the first edge 210a may be bent in the area of the first edge 210a and extended along a second surface 600B facing the first surface 600a. The second area 230b of the display 230 may be rolled into the first housing 210 when the electronic device 200 is in the first state, and may be extracted from the area of the first edge 210a of the first housing 210 when the electronic device 200 is in the second state, so that the second area 230b of the display 230 may form substantially the same surface as the first area 230a.

According to an embodiment, the light emitting circuit 440 and the light receiving circuit 450 may be disposed in the first housing 210. For example, the light emitting circuit 440 may be disposed at the second edge 210b of the first housing 210. The light receiving circuit 450 may be disposed at the third edge 210c of the first housing 210. The light emitting circuit 440 may be disposed at a side surface 600C at which the second edge 210b of the first housing 210 is located. The light receiving circuit 450 may be disposed at a side surface 600D at which a third edge 210c of the first housing 210 is located. The light emitting circuit 440 and the light receiving circuit 450 may be disposed close to the first edge 210a of the first edge 210a and the second edge 210b.

According to an embodiment, the light emitting circuit 440 and the light receiving circuit 450 disposed close to the first edge 210a may be disposed at an area at which the second area 230b of the display 230 is disposed. For example, when the first housing 210 is viewed from the side 600c including the second edge 210b, a portion of the light emitting circuit 440 and a portion of the light receiving circuit 450 may be disposed to be overlapped the second area 230b of the display 230.

According to an embodiment, the light emitting circuit 440 and the light receiving circuit 450 may be electrically connected to a printed circuit board 610. For example, the light emitting circuit 440 may be extended along the side surface 600c at which the third edge 210c is disposed, and may be fastened to the printed circuit board 610, and the light receiving circuit 450 may be extended along the side surface 600d at which the fourth edge 210c is disposed, and may be fastened to the printed circuit board 610.

According to an embodiment, the light emitting circuit 440 disposed at the second edge 210b may face the light receiving circuit 450 disposed at the third edge 210c. The light emitting circuit 440 may be a device that emits light. The light receiving circuit 450 may be a device that obtains an electrical signal from received light. For example, the light emitting circuit 440 may include a light emitting diode, an LED, an IR transmitter, or a laser. The light receiving circuit 450, as a device that detects light, may include a thermal element that detects heat or a photoelectric element that detects a current due to a photoelectric effect. The light receiving circuit 450 may be referred to as an optical sensor.

According to an embodiment, the light emitting circuit 440 and the light receiving circuit 450 facing each other may be configured to detect a foreign substance on the second area 230b when the second area 230b of the display 230 is inserted. For example, the light receiving circuit 450 may be configured to detect an amount of light emitted from the light emitting circuit 440. The light emitting circuit 440 may emit light along a surface of the second area 230b to the light receiving circuit 450. The light emitted from the light emitting circuit 440 may be substantially perpendicular to a moving direction of the display 230. For example, a virtual line connecting the light emitting circuit 440 and the light receiving circuit 450 may be substantially perpendicular to the moving direction of the display 230.

The light emitting circuit 440 may emit light onto the surface of the second area 230b of the display 230, and the emitted light may be transmitted to the light receiving circuit 450. When there is no foreign substance on the display 230, the light emitted from the light emitting circuit 440 may be transmitted to the light receiving circuit 450 without reflection or scattering of light. When there is a foreign substance on the display 230, or the display 230 is convexly deformed toward the first surface 600a, light is reflected or scattered by the foreign substance, or light is reflected by the deformed display 230, so that a portion of the light emitted from the light emitting circuit 440 is lost, and the remaining light may be transmitted to the light receiving circuit 450. Based on the difference in the amount of light transmitted from the light receiving circuit 450, a processor (e.g., the processor 120 in FIG. 1) may detect the existence of the foreign substance or deformation of the display 230.

According to an embodiment, the light receiving circuit 450 has been described as facing the light emitting circuit 440 in order to detect light emitted from the light emitting circuit 440, but is not limited thereto. The light receiving circuit 450 may be disposed to face the same direction as the light emitting circuit 440. For example, the light receiving circuit 450 and the light emitting circuit 440 may be disposed at the second edge 210b to face the third edge 210c. The light emitted from the light emitting circuit 440 may be reflected on the third edge 210c. The light receiving circuit 450 may be disposed parallel to the light emitting circuit 440 to receive the reflected light.

According to an embodiment, the display 230 may include a rolling area that is an area in which the display 230 is bent. The light emitting circuit 440 may be disposed at an end of the first housing 220. The light receiving circuit 450 may be disposed at another end of the first housing.

FIG. 7 illustrates a perspective view representing a light emitting circuit and a light receiving circuit included in an electronic device.

Referring to FIG. 7, a light emitting circuit 440 may include a light source element 441, a first lens 442, a first cable 711, and a first connector 712. A light receiving circuit 450 may include a light receiving element 451, a second lens 452, a second cable 721, and a second connector 722.

According to an embodiment, the light source element 441 may be an element that emits light, and the first lens 442 may guide the light emitted from the light source element 441 to the light receiving element 451. For example, the first lens 442 may proceed the light emitted from the light source element 441 in a direction perpendicular to a moving direction of the display 230. The first lens 442 may provide directionality to light spreading in all directions.

According to an embodiment, the light source element 441 may be electrically connected to a printed circuit board (e.g., the printed circuit board 610 of FIG. 6) through the first cable 711. The first cable 711 may be a flexible printed circuit board or a cable which has flexibility. The first cable 711 may be disposed along an internal surface of the electronic device 200. An end of the first cable 711 may be connected to the light source element 441, and another end of the first cable 711 may be connected to the first connector 712. The first connector 712 may be fastened to the printed circuit board 610. The light source element 441 may receive electrical energy for emitting light through the first cable 711 and receive a control signal.

According to an embodiment, the light receiving element 451 may be electrically connected to the printed circuit board (e.g., the printed circuit board 610 of FIG. 6) through the second cable 721. The second cable 721 may be a flexible printed circuit board or a cable which has flexibility. The second cable 721 may be disposed along the internal surface of the electronic device 200. An end of the second cable 721 may be connected to the light receiving element 451, and another end of the second cable 721 may be connected to the second connector 722. The second connector 722 may be fastened to the printed circuit board 610. The light receiving element 451 may receive electric energy for an operation of the light receiving element 451 through the second cable 721, receive the control signal, or transmit sensing data.

FIG. 8 illustrates an example of a path of a light emitted from a light emitting circuit toward a light receiving circuit according to an embodiment.

Referring to FIG. 8, a light emitting circuit 440 may include a light source element 441 and a first lens 442. The light receiving circuit 450 may include a light receiving element 451 and a second lens 452. For example, the light emitting circuit 440 may be configured with a vertical-cavity surface-emitting laser (VCSEL) diode.

For example, the light source element 441 may be used to emit light. The processor 410 may emit the light using the light source element 441. The light source element 441 may omnidirectionally emit the light. The first lens 442 may change a path of the light so that the light omnidirectionally emitted is emitted toward the light receiving circuit 450 based on a directional beam. For example, the first lens 442 may be formed of an aspherical lens.

For example, the path of light emitted toward the light receiving circuit 450 may be changed by the second lens 452. The second lens 452 may change the path of light so that the light emitted based on the directional beam is concentrated in a focus. For example, the second lens 452 may be formed of an aspherical lens. The light receiving element 451 may receive the light concentrated by the second lens 452. For example, the light receiving element 451 may be configured with an image sensor. The light receiving element 451 may identify an amount of light by converting received light energy into an electrical signal. The light receiving circuit 450 may obtain data on the received light based on the amount of light received through the light receiving element 451 or the magnitude of the electrical signal.

According to an embodiment, the processor 410 may emit light according to a predefined amount of light through the light emitting circuit 440. The processor 410 may receive the light emitted from the light emitting circuit 440 by using the light receiving circuit 450. The processor 410 may identify the amount of light emitted by using the light receiving circuit 450 while a display area is reduced. The processor 410 may identify an abnormal state in the display area based on the amount of emitted light. For example, the processor 410 may identify an abnormal state of a partial area in the display area based on the amount of emitted light.

For example, the processor 410 may identify whether the amount of light of light is constantly maintained. The processor 410 may identify the abnormal state of the partial area in the display area based on identifying that the amount of light is not constantly maintained. For another example, the processor 410 may identify whether the amount of light is equal to or less than a reference amount of light. The processor 410 may identify the abnormal state of the partial area in the display area based on identifying that the amount of light is equal to or less than the reference amount of light.

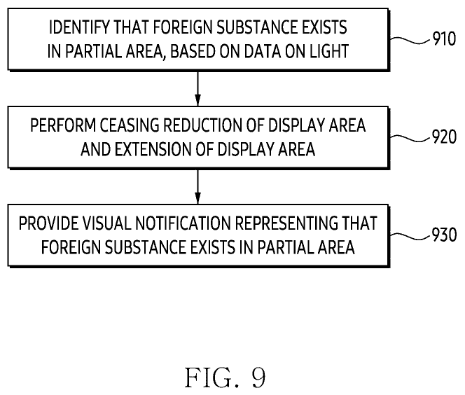

FIG. 9 illustrates a flowchart about an operation of an electronic device according to an embodiment.

Referring to FIG. 9, in operation 910, a processor 410 may identify that a foreign substance exists in a partial area based on data on light. For example, the processor 410 may identify the existence of the foreign substance in the partial area based on the data on the light received using the light receiving circuit 450.

According to an embodiment, the foreign substance may exist in a partial area (or on the partial area) in the display area. As the display 420 is inserted into a first housing, the foreign substance may be inserted into the first housing together. As the foreign substance is inserted into the first housing, a problem may occur in an electronic device 200. The processor 410 may identify that the foreign substance exists in the partial area before the foreign substance is inserted into the first housing together.

In operation 920, the processor 410 may perform ceasing reduction of the display area and perform extension of the display area. For example, in response to identifying the existence of the foreign substance in the partial area, the processor 410 may perform ceasing the reduction of the display area and perform extension of the display area. Operation 920 may correspond to the operation 540 of FIG. 5.

According to an embodiment, after identifying that the foreign substance exists in the partial area, the processor 410 may cease the reduction of the display area and extend the display area to a maximum size.

In operation 930, the processor 410 may provide a visual notification representing that the foreign substance exists in the partial area. For example, the processor 410 may provide the visual notification representing that the foreign substance exists in the partial area in a state that the display area is extended. Operation 930 may correspond to the operation 550 of FIG. 5.

According to an embodiment, the processor 410 may induce a user of the electronic device 200 to remove the foreign substance by providing the visual notification representing that the foreign substance exists in the partial area.

According to an embodiment, the processor 410 may identify the partial area. According to an embodiment, the processor 410 may not be able to identify an exact location of the foreign substance. The processor 410 may set the partial area to include an area in which the foreign substance exists. For example, the processor 410 may identify existence of the foreign substance using the light receiving circuit 450. In a time point when it is identified that a foreign substance exists, the processor 410 may identify a first area corresponding to a curved portion of the display area, a second area extended from the curved portion of the display area in a first direction by a reference distance, and the third area extended from the display area by the reference distance in a second direction opposite to the first direction, as a partial area.

According to an embodiment, the processor 410 may display an element representing the location of the foreign substance in the partial area together with the visual notification. For example, the processor 410 may display the element representing that the foreign substance is located in the partial area. The processor 410 may guide the user of the electronic device 200 to recognize that the foreign substance is located in the partial area by displaying the element representing that the foreign substance is located in the partial area.

For example, the processor 410 may display the element representing the location of the foreign substance by changing luminance of the partial area. For another example, the processor 410 may display the element representing the location of the foreign substance by displaying the visual object in the partial area.

The processor 410 may provide a black image through a remaining area of the display area except for the partial area. The black image may mean an image in which a color of all areas (e.g., the remaining areas of the display area except for the partial area) is black. According to an embodiment, the processor 410 may provide a black image by deactivating the panel of the display 420 corresponding to the remaining area of the display area except for the partial area. The processor 410 may display a visual object (or image) of a predefined color in the partial area of the display area. For example, the predefined color may be white.

According to an embodiment, the processor 410 may accurately identify the location of the foreign substance in the partial area. The processor 410 may display the element representing the exact location of the foreign substance in the partial area.

According to an embodiment, after the visual notification is displayed, the processor 410 may receive an input for reducing of the display area. The processor 410 may reduce the display area based on the input. For example, the processor 410 may change a speed at which the display area is reduced in a first time point that the partial area starts to change from a planar portion to a curved portion. The processor 410 may change the speed at which the display area is reduced by changing a rotation speed of a motor included in a driving device 430.

For example, the processor 410 may set a speed at which the display area is reduced from the first time point to a second time point at which the partial area is all inserted into the first housing, as a first speed. The processor 410 may change the speed at which the display area is reduced, before the first time point or after the second time point, to a second speed greater than the first speed.

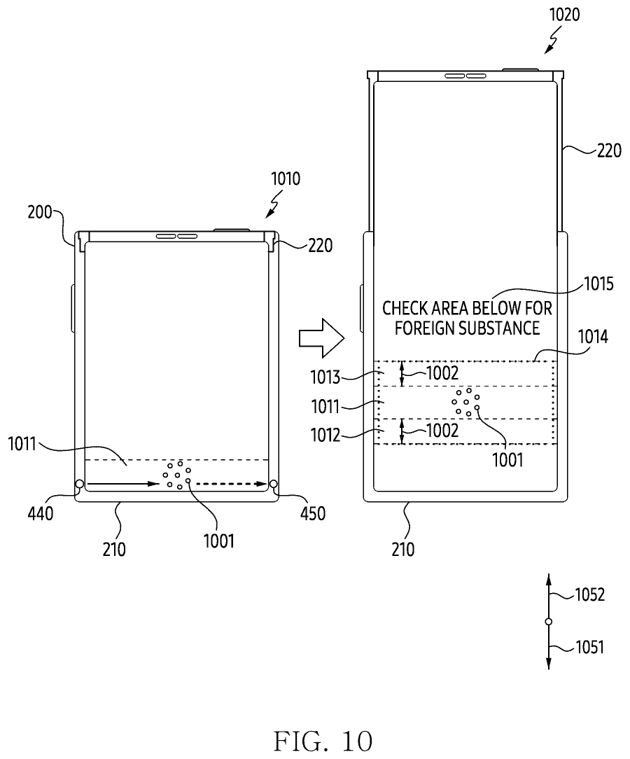

FIG. 10 illustrates an example of an operation of an electronic device according to an embodiment.

Referring to FIG. 10, a state 1010 may indicate a situation in which a display area of a display 420 is reduced.

According to an embodiment, a processor 410 may receive an input for reducing the display area of the display 420 exposed outside a first housing 210. The processor 410 may reduce the display area based on the input. The processor 410 may emit light to a light receiving circuit 450 by using a light emitting circuit 440 while the display area is reduced.

According to an embodiment, a foreign substance 1001 may exist on a first area 1011. As the display area is reduced, the first area 1011 may be changed from a planar portion to a curved portion. The state 1010 may be a state in which the first area 1011 is changed to the curved portion. In the state 1010, the processor 410 may identify an existence of the foreign substance 1001 in a partial area 1014 based on data on light obtained using the light receiving circuit 450.

For example, the partial area 1014 may include the first area 1011, a second area 1012 extended by a reference distance 1002 in a first direction 1051 from the first aera 1011, and a third area 1013 extended by the reference distance 1002 in a second direction 1052 opposite to the first direction 1051 from the first area 1011. The processor 410 may identify the first area 1011, the second area 1012, and the third area 1013, as the partial area 1014.

According to an embodiment, the processor 410 may cease the reduction of the display area and extend the display area to a maximum size after identifying that the foreign substance 1001 exists in the partial area 1014. For example, the processor 410 may identify that the foreign substance 1001 exists in the state 1010. The processor 410 may change a state of an electronic device 200 from the state 1010 to a state 1020 by extending the display area.

In the state 1020, the processor 410 may provide a visual notification 1015 representing that the foreign substance 1001 exists in the partial area 1014. For example, the processor 410 may provide the visual notification 1015 by displaying text representing that the foreign substance 1001 exists in the partial area 1014.

According to an embodiment, in the state 1020, the processor 410 may display an element representing a location of the foreign substance 1001 with the visual notification 1015. For example, the processor 410 may display a visual object (or image) of a predefined color (e.g., white) in the partial area 1014. The processor 410 may provide a black image in a remaining area except for the partial area 1014 in the display area. The processor 410 may display the visual object of the predefined color in the partial area 1014 so that a user of the electronic device 200 may easily detect the foreign substance 1001.

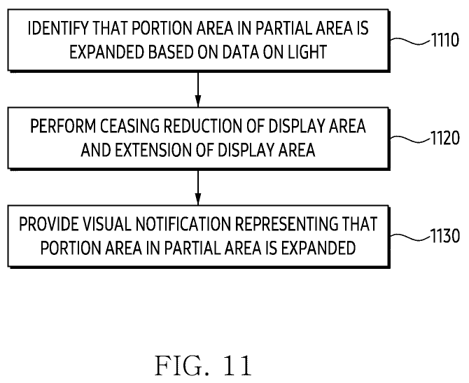

FIG. 11 illustrates a flowchart about an operation of an electronic device according to an embodiment.

Referring to FIG. 11, in operation 1110, a processor 410 may identify that a portion area in a partial area is expanded based on data on light. For example, the processor 410 may identify that the portion area within the partial area has expanded based on the data on the light received using a light receiving circuit 450.

According to an embodiment, the portion area (or an entire area of the partial area) in the partial area may be expanded due to repeated extension or reduction of a display area. A state in which the portion area is expanded may be referred to as a state in which the portion area is lifted or a state in which a bulge occurs in the portion area. For example, as the expanded partial area is inserted into a first housing, a problem may occur in an electronic device 200. The processor 410 may identify that the partial area is expanded before the expanded partial area is inserted into the first housing.

In operation 1120, the processor 410 may perform ceasing the reduction of the display area and perform the extension of the display area. For example, the processor 410 may perform ceasing the reduction of the display area and perform the extension of the display area in response to identifying that the portion area in the partial area is expanded. Operation 1120 may correspond to the operation 540 of FIG. 5.

In operation 1130, the processor 410 may provide a visual notification representing that the portion area in the partial area is expanded. For example, the processor 410 may provide the visual notification representing that the portion area in the partial area is expanded in a state that the display area is extended.

According to an embodiment, the processor 410 may provide information so that a user of the electronic device 200 may recognize it by providing the visual notification representing that the portion area in the partial area is expanded.

According to an embodiment, the processor 410 may identify the partial area. According to an embodiment, the processor 410 may not be able to identify an exact location of the expanded portion area. The processor 410 may set the partial area to include the expanded portion area. For example, the processor 410, in a time point of identification that the expanded portion area exists, may identify a first area corresponding to a curved portion of the display area, a second area extended from the curved portion of the display area by a reference distance in a first direction, and the third area extended from the display area by the reference distance in a second direction opposite to the first direction, as the partial area.

According to an embodiment, the processor 410 may display an element indicating that the portion area in the partial area is expanded together with the visual notification. For example, the processor 410 may display the element indicating that the expanded portion area exists in the partial area. The processor 410 may guide the user of the electronic device 200 to recognize that the expanded portion area exists in the partial area by displaying the element indicating that the expanded portion area exists in the partial area.

For example, by changing the luminance of the partial area, the processor 410 may display the element indicating that the portion area is expanded in the partial area. For another example, the processor 410 may display the element indicating that the portion area in the partial area is expanded by displaying a visual object in the partial area.

The processor 410 may provide a black image through a remaining area of the display area except for the partial area. The black image may mean an image in which the color of all areas (e.g., the remaining areas of the display area except for the partial area) is black. According to an embodiment, the processor 410 may provide the black image by deactivating the panel of the display 420 corresponding to the remaining area of the display area except for the partial area. The processor 410 may display a visual object (or image) of a predefined color in the partial area of the display area. For example, the predefined color may be white.

According to an embodiment, the processor 410 may accurately identify the location of the expanded portion area in the partial area. The processor 410 may display the element indicating the exact location of the expanded portion area in the partial area.

According to an embodiment, the processor 410 may block an input for the reduction of the display area after the visual notification is displayed. The processor 410 may refrain from the reduction of the display area based on identifying that the portion area in the partial area is expanded. For example, the processor 410 may refrain from the reduction of the display area by blocking the input for the reduction of the display area.

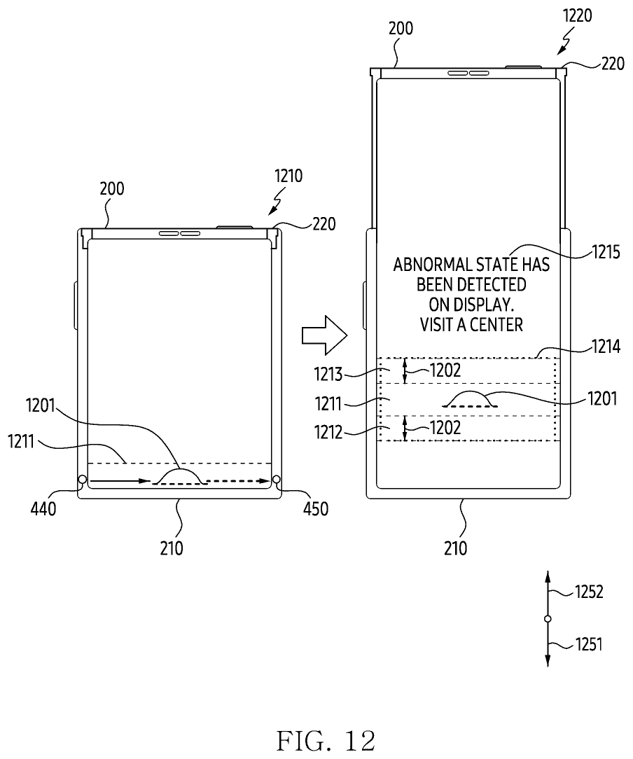

FIG. 12 illustrates an example of an operation of an electronic device according to an embodiment.

Referring to FIG. 12, a state 1210 may indicate a situation in which the display area of display 420 is reduced.

According to an embodiment, a processor 410 may receive an input for reducing a display area of the display 420 exposed outside a first housing 210. The processor 410 may reduce the display area based on the input. The processor 410 may emit light to a light receiving circuit 450 by using a light emitting circuit 440 while the display area is reduced.

According to an embodiment, an expanded area 1201 may exist on a first area 1211. As the display area is reduced, the first area 1211 may be changed from a planar portion to a curved portion. The state 1210 may be a state in which the first area 1211 is changed to the curved portion. In the state 1210, the processor 410 may identify that an expanded area 1201 exists in a partial area 1214 based on data on light obtained using a light receiving circuit 450.

For example, the partial area 1214 may include a first area 1211, a second area 1212 extended from the first area 1211 by a reference distance 1202 in a first direction 1251, and a third area extended from the first area 1211 by the reference distance 1202 in a second direction 1252 which is opposite to the first direction 1251. The processor 410 may identify the first area 1211, the second area 1212, and the third area 1213, as the partial area 1214.

According to an embodiment, after identifying that the expanded area 1201 exists in the partial area 1214, the processor 410 may cease reduction of the display area and extend the display area to a maximum size. For example, the processor 410 may identify that the expanded area 1201 exists in the state 1210. The processor 410 may change a state of the electronic device 200 from the state 1210 to a state 1220 by extending the display area. The expanded area 1201 may be a portion of the display that has experienced an abnormal change.

In the state 1220, the processor 410 may provide a visual notification 1215 representing that a foreign substance exists in the partial area 1214. For example, the processor 410 may provide the visual notification 1215 by displaying a text indicating that the expanded area 1201 exists in the partial area 1214. The text may indicate that the user needs to take the device 200 to a service center.

According to an embodiment, in the state 1220, the processor 410 may display an element indicating a location of the expanded area 1201 together with the visual notification 1215. For example, the processor 410 may display a visual object (or image) of a predefined color (e.g., white) in the partial area 1214. The processor 410 may provide a black image in a remaining area except for the partial area 1214 in the display area. The processor 410 may display the visual object of a predefined color in the partial area 1214, so that a user of the electronic device 200 may easily detect the foreign substance.

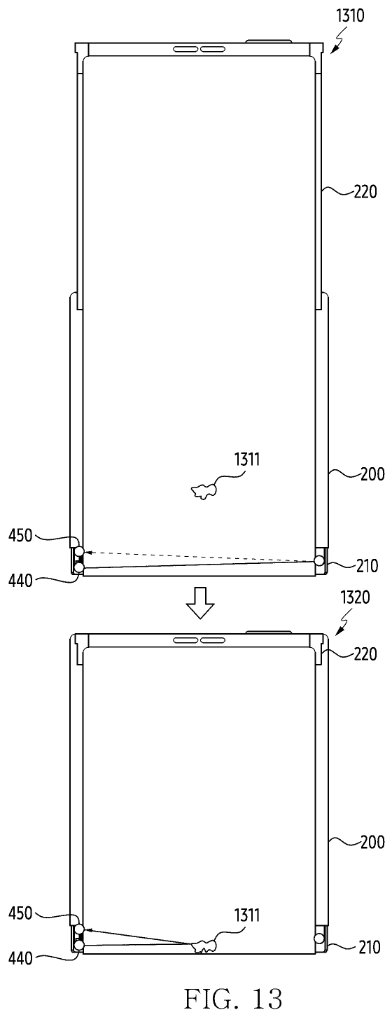

FIG. 13 illustrates an example of an operation of an electronic device according to an embodiment.

Referring to FIG. 13, unlike the above-described embodiments, a light emitting circuit 440 may be disposed at an end of an edge of the electronic device 200 together with a light receiving circuit 450. A state 1310 may indicate a state in which a display area of a display 420 is extended.

According to an embodiment, in a state 1310, a foreign substance 1311 may exist on the display area. The processor 410 may receive an input for reducing the display area in a state in which the foreign substance 1311 exists. The processor 410 may reduce the display area based on the input. The processor 410 may change a state of the electronic device 200 from the state 1310 to a state 1320 by reducing the display area. The state 1320 may indicate a situation in which the display area of the display 420 is reduced.

According to an embodiment, while an area in which the foreign substance does not exist is changed from a planar portion to a curved portion, the processor 410 may emit light in a direction parallel to a first edge at which the display 420 is inserted into the first housing 210 of the electronic device 200, by using the light emitting circuit 440. In a normal state, the light receiving circuit 450 may not receive the light emitted from the light emitting circuit 440.

According to an embodiment, a reflective device (not shown) for reflecting light may be disposed at a position facing the light emitting circuit 440. The light emitted from the light emitting circuit 440 may be reflected by the reflective device and received by the light receiving circuit 450. When the reflective device is included in the electronic device 200, in the normal state, the light receiving circuit 450 may receive the light emitted from the light emitting circuit 440 to the reflective device.

According to an embodiment, in a state 1320, the light emitted from the light emitting circuit 440 may be reflected by the foreign substance 1311. The processor 410 may receive the reflected light using the light receiving circuit 450. The processor 410 may identify data on the light by receiving the reflected light using the light receiving circuit 450. The processor 410 may identify an abnormal state of a partial area in the display area based on the data on the light. For example, the processor 410 may obtain data on a location where the abnormal state is identified in the partial area, based on the data on the light.

According to an embodiment, the light emitted by using the light emitting circuit 440 is reflected in the partial area and received through the light receiving circuit 450. The processor 410 may identify a location at which light is reflected as a location where an abnormal state occurs in a partial area.

According to an embodiment, the data on the light obtained using the light receiving circuit 450 may include data on an amount of the reflected light, in which the emitted light, using the light emitting circuit 440, reflects at the partial area and is obtained using the light receiving circuit 450, and may include data on a first time point at which the light is emitted from the light emitting circuit 440 and may include data on a second time point at which the reflected light is received (or acquired) using the light receiving circuit. The processor 410 may identify a location at which light is reflected in the partial area based on the first time point and the second time point. The processor 410 may identify the location of the foreign substance 1311 in the partial area by identifying the location where light is reflected in the partial area.

According to an embodiment, the processor 410 may transmit the light based on a first pattern by using the light emitting circuit 440. The processor 410 may use the light receiving circuit 450 to identify that the light reflected from the partial area is received based on a second pattern. The processor 410 may identify a location where the light is reflected in the partial area based on the first pattern and the second pattern. The processor 410 may identify the location of the foreign substance 1311 in the partial area by identifying the location where the light is reflected in the partial area.

According to an embodiment, the processor 410 may extend the display area after identifying the location where light is reflected. The processor 410 may identify the location at which light is reflected as the location where the abnormal state occurs in the partial area. The processor 410 may provide the visual notification by displaying a visual affordance at the location where the abnormal state occurs.

According to an embodiment, an electronic device may comprise a first housing, a second housing slidably coupled to the first housing, a flexible display disposed on a surface formed by the first housing and the second housing, which is insertable into the first housing or extractable from the first housing, the flexible display may include a rolling area where the flexible display is bent, a driving device for driving the second housing to slide in or slide out, a light emitting circuit disposed at an end of the first housing, which is a rolling area where the flexible display is bent, a light receiving circuit disposed at another end of the first housing, which is the rolling area where the flexible display is bent, memory including one or more storage mediums storing instructions, and at least one processor including processing circuitry The instructions, when being executed by the at least one processor individually or collectively, may cause the electronic device to emit light using the light emitting circuit, based on insertion or extraction of the flexible display. The instructions, when being executed by the at least one processor individually or collectively, may cause the electronic device to identify an abnormal state in a display area of the flexible display using the light receiving circuit. The instructions, when being executed by the at least one processor individually or collectively, may cause the electronic device to, in response to the identification, provide a visual notification for the abnormal state in the display area of the flexible display.

According to an embodiment, the light emitting circuit may comprise a first light source element for emitting the light, and a first lens for emitting, based on a directional beam, the light to the light receiving circuit. The light receiving circuit may comprise a second lens for focusing the light emitted based on the directional beam, and a second light source element for receiving the focused light. The instructions, when being executed by the at least one processor individually or collectively, may cause the electronic device to obtain data related to the light using the light receiving circuit.

According to an embodiment, the instructions, when being executed by the at least one processor individually or collectively, may cause the electronic device to emit, based on the directional beam, the light from the light emitting circuit to the light receiving circuit in a direction parallel to a first edge.

According to an embodiment, the instructions, when being executed by the at least one processor individually or collectively, may cause the electronic device to identify the abnormal state of a partial area in the display area based on the data related to the light. The instructions, when being executed by the at least one processor individually or collectively, may cause the electronic device to, in response to the identification, perform ceasing reduction of the display area and perform extension of the display area. The visual notification may be provided for representing the abnormal state of the partial area in a state in which the display area is extended.

According to an embodiment, the instructions, when being executed by the at least one processor individually or collectively, may cause the electronic device to identify an amount of the light received using the light receiving circuit based on the data related to the light. The instructions, when being executed by the at least one processor individually or collectively, may cause the electronic device to, based on identifying that the amount of the light is less than a reference amount of light, identify the abnormal state of the partial area.

According to an embodiment, the instructions, when being executed by the at least one processor individually or collectively, may cause the electronic device to, based on the data related to the light, obtained using the light receiving circuit, identify a normal state of the display area. The instructions, when being executed by the at least one processor individually or collectively, may cause the electronic device to, based on the normal state of the display area, reduce the display area to the minimum size.

According to an embodiment, the abnormal state may comprise a state that a foreign substance exists in the partial area or a state that a portion area in the partial area is expanded.

According to an embodiment, the instructions, when being executed by the at least one processor individually or collectively, may cause the electronic device to, based on the data related to the light received using the light receiving circuit, identify that the foreign substance exists in the partial area. The instructions, when being executed by the at least one processor individually or collectively, may cause the electronic device to, in response to identifying that the foreign substance exists in the partial area, perform ceasing the reduction of the display area and perform the extension of the display area. The instructions, when being executed by the at least one processor individually or collectively, may cause the electronic device to provide the visual notification representing that the foreign substance exists in the partial area in the state in which the display area is extended.

According to an embodiment, the instructions, when being executed by the at least one processor individually or collectively, may cause the electronic device to display an element indicating a location of the foreign substance in the partial area with the visual notifications.

According to an embodiment, the instructions, when being executed by the at least one processor individually or collectively, may cause the electronic device to display the element indicating the location of the foreign substance by changing luminance of the partial area.

According to an embodiment, the instructions, when being executed by the at least one processor individually or collectively, may cause the electronic device to display the element indicating the location of the foreign substance by displaying a visual object on the partial area.

According to an embodiment, the instructions, when being executed by the at least one processor individually or collectively, may cause the electronic device to identify that the portion area in the partial area is expanded based on the data related to the light received using the light receiving circuit. The instructions, when being executed by the at least one processor individually or collectively, may cause the electronic device to, in response to identifying that the portion area in the partial area is expanded, perform ceasing the reduction of the display area and perform the extension of the display area. The instructions, when being executed by the at least one processor individually or collectively, may cause the electronic device to provide the visual notification representing that the portion area in the partial area is expanded in a state in which the display area is extended.

According to an embodiment, the instructions, when being executed by the at least one processor individually or collectively, may cause the electronic device to reduce the display area by inserting, through the first edge, the flexible display into the first housing in a first direction orthogonal to the first edge. The instructions, when being executed by the at least one processor individually or collectively, may cause the electronic device to extend the display area by extracting, through the first edge, the flexible display from the first housing in a second direction opposite to the first direction.

According to an embodiment, the partial area may be changed from a planar portion to a curved portion by moving according to the reduction of the display area. The partial area may be changed from the curved portion to the planar portion by moving according to the extension of the display area.

According to an embodiment, the instructions, when being executed by the at least one processor individually or collectively, may cause the electronic device to identify an amount of the light received using the light receiving circuit based on the data related to the light. The instructions, when being executed by the at least one processor individually or collectively, may cause the electronic device to identify, in a time point that it is identified that the amount of the light is lower than the reference amount of light, a first area corresponding to a curved portion of the display area, a second area extended from the curved portion of the display area by a reference distance in the first direction, and a third area extended from the curved portion of the display area by the reference distance in the second direction, as the partial area.

According to an embodiment, the instructions, when being executed by the at least one processor individually or collectively, may cause the electronic device to refrain from emitting light to the light receiving circuit using the light emitting circuit while the extension of the display area is performed.

According to an embodiment, an electronic device may comprise a first housing, a second housing slidably coupled to the first housing, a flexible display disposed on a surface formed by the first housing and the second housing, which is insertable into the first housing through a first edge of the first housing or extractable from the first housing through the first edge, a driving device for inserting the flexible display into the first housing or extracting the flexible display from the first housing, a light emitting circuit disposed at an end of the second edge in contact with the first edge included in the second edge of the first housing perpendicular to the first edge, a light receiving circuit disposed at an end of the second edge with the light emitting circuit, and at least one processor operably coupled with the flexible display, the driving device, the light emitting circuit, and the light receiving circuit. The at least one processor may be configured to emit light using the light emitting circuit, based on an input for reducing the display area of the flexible display which is exposed outside of the first housing, while the flexible display, through the first edge, is inserted into the first housing. The at least one processor may be configured to identify an abnormal state of a partial area in the display area, based on the data on the light obtained using the light receiving circuit. The at least one processor may be configured to, in response to the identification, perform ceasing the reduction of the display area and perform the extension of the display area. The at least one processor may be configured to provide a visual notification for an abnormal state of the partial area, in a state that the display area is extended.

According to an embodiment, the at least one processor may be configured to obtain data on a location where the abnormal state is identified in the partial area based on the data on the light.

According to an embodiment, the data on the light may include data on the amount of the light in which the light emitted using the light emitting circuit is reflected at the partial area, and obtained using the light receiving circuit, data on the first time point at which the light is emitted from the light emitting circuit, and data on the second time point at which the light is received using the light receiving circuit.

According to an embodiment, the at least one processor may be configured to transmit the light based on the first pattern using the light emitting circuit. The at least one processor may be configured to identify that light, using the light receiving circuit, reflected from the partial area is received based on the second pattern. The at least one processor may be configured to identify a location at which the light is reflected in the partial area, based on the first pattern and the second pattern.

According to an embodiment, the at least one processor may be configured to identify the location at which the light is reflected as a location where the abnormal state occurs within the partial area. The at least one processor may be configured to provide the visual notification by displaying a visual affordance at the location where the abnormal state occurs.

According to an embodiment, a method of an electronic device may comprise emitting, based on insertion or extraction of a flexible display of the electronic device, light using a light emitting circuit disposed at an end of the first housing of the electronic device, which is a rolling area where the flexible display is bent. The method may comprise identifying an abnormal state in a display area, using the light receiving circuit disposed at another end of the first housing, which is the rolling area where the flexible display is bent. The method may comprise, in response to the identification, providing a visual notification for the abnormal state of the flexible display.

According to an embodiment, a method of an electronic device may comprise emitting, based on insertion or extraction of a flexible display of the electronic device, light using a light emitting circuit of the electronic device. The method may comprise identifying an abnormal state in a display area, using the light receiving circuit of the electronic device. The method may comprise providing a visual notification for the abnormal state in the flexible display.

According to an embodiment, the light emitting circuit may comprise a first light source element for emitting the light, and a first lens for emitting, based on a directional beam, the light to the light receiving circuit. The light receiving circuit may comprise a second lens for focusing the light emitted based on the directional beam, and a second light source element for receiving the focused light. The method may comprise obtaining data related to the light using the light receiving circuit.

According to an embodiment, the method may comprise emitting, based on the directional beam, the light from the light emitting circuit to the light receiving circuit in a direction parallel to a first edge at which the flexible display is inserted to the first housing.

According to an embodiment, the method may comprise identifying the abnormal state of a partial area in the display area based on the data related to the light. The method may comprise, in response to the identification, performing ceasing reduction of the display area and performing extension of the display area. The visual notification may be provided for representing the abnormal state of the partial area in a state in which the display area is extended.

According to an embodiment, the method may comprise identifying an amount of the light received using the light receiving circuit based on the data related to the light. The method may comprise, based on identifying that the amount of the light is less than a reference amount of light, identifying the abnormal state of the partial area.

According to an embodiment, the method may comprise, based on the data related to the light, obtained using the light receiving circuit, identifying a normal state of the display area. The method may comprise, based on the normal state of the display area, reducing the display area to the minimum size.

According to an embodiment, the abnormal state may comprise a state that a foreign substance exists in the partial area or a state that a portion area in the partial area is expanded.

According to an embodiment, the method may comprise, based on the data related to the light received using the light receiving circuit, identifying that the foreign substance exists in the partial area. The method may comprise, in response to identifying that the foreign substance exists in the partial area, performing ceasing the reduction of the display area and performing the extension of the display area. The method may comprise providing the visual notification representing that the foreign substance exists in the partial area in the state in which the display area is extended.

According to an embodiment, the method may comprise displaying an element indicating a location of the foreign substance in the partial area with the visual notification.

According to an embodiment, the method may comprise displaying the element indicating the location of the foreign substance by changing luminance of the partial area.

According to an embodiment, the method may comprise displaying the element indicating the location of the foreign substance by displaying a visual object on the partial area.

According to an embodiment, the method may comprise identifying that the portion area in the partial area is expanded based on the data related to the light received using the light receiving circuit. The method may comprise, in response to identifying that the portion area in the partial area is expanded, performing ceasing the reduction of the display area and performing the extension of the display area. The method may comprise providing the visual notification representing that the portion area in the partial area is expanded in a state in which the display area is extended.

According to an embodiment, the method may comprise reducing the display area by inserting, through the first edge, the flexible display into the first housing in a first direction orthogonal to the first edge. The method may comprise extending the display area by extracting, through the first edge, the flexible display from the first housing in a second direction opposite to the first direction.

According to an embodiment, the partial area may be changed from a planar portion to a curved portion by moving according to the reduction of the display area. The partial area may be changed from the curved portion to the planar portion by moving according to the extension of the display area.

According to an embodiment, the method may comprise identifying the amount of light received using the light receiving circuit based on the data on the light. The method may comprise, in a time point that it is identified that the amount of the light is lower than the reference amount of light, identifying a first area corresponding to a curved portion of the display area, a second area extended from the curved portion of the display area by a reference distance in the first direction, and a third area extended from the curved portion of the display area by the reference distance in the second direction, as the partial area.

According to an embodiment, the method may comprise refraining from emitting light to the light receiving circuit using the light emitting circuit while the extension of the display area is performed.

According to an embodiment, the method may comprise obtaining the data on the location where the abnormal state is identified in the partial area based on the data on the light.

According to an embodiment, the data on the light may comprise data on the amount of the light in which the light emitted using the light emitting circuit is reflected at the partial area, and obtained using the light receiving circuit, data on the first time point emitted at which the light is emitted from the light emitting circuit, and data on the second time point at which the light is received using the light receiving circuit.

According to an embodiment, the method may comprise transmitting the light based on the first pattern using the light emitting circuit. The method may comprise identifying that light, using the light receiving circuit, reflected from the partial area is received based on the second pattern. The method may comprise identifying a location at which the light is reflected in the partial area, based on the first pattern and the second pattern.

According to an embodiment, the method may comprise identifying the location at which the light is reflected as a location where the abnormal state occurs within the partial area. The method may comprise providing the visual notification by displaying a visual affordance at the location where the abnormal state occurs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a first housing;
a second housing slidably coupled to the first housing;
a flexible display disposed on a surface formed by the first housing and the second housing, which is insertable into the first housing or extractable from the first housing;
a driving device for driving the second housing to slide in or slide out;
a light emitting circuit disposed at an end of the first housing, which is a rolling area where the flexible display is bent;
a light receiving circuit disposed at another end of the first housing, which is the rolling area where the flexible display is bent;
memory including one or more storage mediums storing instructions; and
at least one processor including processing circuitry,
wherein the instructions, when being executed by the at least one processor individually or collectively, cause the electronic device to:
emit, based on insertion or extraction of the flexible display, light using the light emitting circuit,
identify, using the light receiving circuit, an abnormal state in a display area of the flexible display, and
in response to the identification, provide a visual notification for the abnormal state in the display area of the flexible display.

2. The electronic device of claim 1, wherein the light emitting circuit comprise:
a first light source element for emitting the light, and
a first lens for emitting, based on a directional beam, the light to the light receiving circuit;
wherein the light receiving circuit comprise:
a second lens for focusing the light emitted based on the directional beam, and
a second light source element for receiving the focused light; and
wherein the at least one processor is configured to obtain data related to the light using the light receiving circuit.

3. The electronic device of claim 2, wherein the instructions, when being executed by the at least one processor individually or collectively, cause the electronic device to emit, based on the directional beam, the light from the light emitting circuit to the light receiving circuit in a direction parallel to a first edge.

4. The electronic device of claim 3, wherein the instructions, when being executed by the at least one processor individually or collectively, cause the electronic device to:
identify the abnormal state of a partial area in the display area based on the data related to the light, and
in response to the identification, perform ceasing reduction of the display area and perform extension of the display area; and
wherein the visual notification is provided for representing the abnormal state of the partial area in a state in which the display area is extended.

5. The electronic device of claim 4, wherein the instructions, when being executed by the at least one processor individually or collectively, cause the electronic device to:
identify an amount of the light received using the light receiving circuit based on the data related to the light, and
based on identifying that the amount of the light is less than a reference amount of light, identify the abnormal state of the partial area.

6. The electronic device of claim 4, wherein the instructions, when being executed by the at least one processor individually or collectively, cause the electronic device to:
based on the data related to the light, obtained using the light receiving circuit, identify a normal state of the display area, and
based on the normal state of the display area, reduce the display area to the minimum size.

7. The electronic device of claim 4, wherein the abnormal state comprises a state that a foreign substance exists in the partial area or a state that a portion area in the partial area is expanded.

8. The electronic device of claim 7, wherein the instructions, when being executed by the at least one processor individually or collectively, cause the electronic device to:
based on the data related to the light received using the light receiving circuit, identify that the foreign substance exists in the partial area,
in response to identifying that the foreign substance exists in the partial area, perform ceasing the reduction of the display area and perform the extension of the display area, and
provide the visual notification representing that the foreign substance exists in the partial area in the state in which the display area is extended.

9. The electronic device of claim 8, wherein the instructions, when being executed by the at least one processor individually or collectively, cause the electronic device to display an element indicating a location of the foreign substance in the partial area with the visual notification.

10. The electronic device of claim 9, wherein the instructions, when being executed by the at least one processor individually or collectively, cause the electronic device to display the element indicating the location of the foreign substance by changing luminance of the partial area.

11. The electronic device of claim 9, wherein the instructions, when being executed by the at least one processor individually or collectively, cause the electronic device to display the element indicating the location of the foreign substance by displaying a visual object on the partial area.

12. The electronic device of claim 7, wherein the instructions, when being executed by the at least one processor individually or collectively, cause the electronic device to:
identify that the portion area in the partial area is expanded based on the data related to the light received using the light receiving circuit,
in response to identifying that the portion area in the partial area is expanded, perform ceasing the reduction of the display area and perform the extension of the display area, and
provide the visual notification representing that the portion area in the partial area is expanded in a state in which the display area is extended.

13. The electronic device of claim 4, wherein the instructions, when being executed by the at least one processor individually or collectively, cause the electronic device to:
reduce the display area by inserting, through the first edge, the flexible display into the first housing in a first direction orthogonal to the first edge, and
extend the display area by extracting, through the first edge, the flexible display from the first housing in a second direction opposite to the first direction.

14. The electronic device of claim 13, wherein the partial area is changed from a planar portion to a curved portion by moving according to the reduction of the display area, and
wherein the partial area is changed from the curved portion to the planar portion by moving according to the extension of the display area.

15. A method of an electronic device, comprising:
emitting, based on insertion or extraction of a flexible display of the electronic device, light using a light emitting circuit disposed at an end of a first housing of the electronic device, which is a rolling area where the flexible display is bent,
identifying an abnormal state in a display area, using the light receiving circuit disposed at another end of the first housing, which is the rolling area where the flexible display is bent, and
in response to the identification, providing a visual notification for the abnormal state of the flexible display.

16. The method of claim 15, wherein the light emitting circuit comprise:
a first light source element for emitting the light, and
a first lens for emitting, based on a directional beam, the light to the light receiving circuit;
wherein the light receiving circuit comprise:
a second lens for focusing the light emitted based on the directional beam, and
a second light source element for receiving the focused light; and
wherein the method comprises obtaining data related to the light using the light receiving circuit.

17. The method of claim 16, wherein the method comprises emitting, based on the directional beam, the light from the light emitting circuit to the light receiving circuit in a direction parallel to a first edge.

18. The method of claim 16, wherein the method comprises:
identifying the abnormal state of a partial area in the display area based on the data related to the light, and
in response to the identification, performing ceasing reduction of the display area and perform extension of the display area; and
wherein the visual notification is provided for representing the abnormal state of the partial area in a state in which the display area is extended.

19. The method of claim 18, wherein the method comprises:
identifying an amount of the light received using the light receiving circuit based on the data related to the light, and
based on identifying that the amount of the light is less than a reference amount of light, identifying the abnormal state of the partial area.

20. The method of claim 18, wherein the method comprises:
based on the data related to the light, obtained using the light receiving circuit, identifying a normal state of the display area, and
based on the normal state of the display area, reducing the display area to the minimum size.
